(19) United States
(12) Patent Application Publication
(10) Pub. No.: US 2015/0232755 A1
(43) Pub. Date: Aug. 20, 2015

(54) STANNATE LUMINESCENT MATERIAL AND PREPARATION METHOD THEREOF

(71) Applicants: Mingjie Zhou, Shenzhen (CN); Rong Wang, Shenzhen (CN)

(72) Inventors: Mingjie Zhou, Shenzhen (CN); Rong Wang, Shenzhen (CN)

(73) Assignees: Ocean's King Lighting Science & Technology Co. Ltd, Shenzhen, Guangdong (CN); Shenzhen Ocean's King Lighting Engineering Co., Ltd, Shenzhen Guangdong (CN)

(21) Appl. No.: 14/427,348

(22) PCT Filed: Sep. 11, 2012
(86) PCT No.: PCT/CN2012/081249

§ 371 Date: Mar. 11, 2015

(51) Int. Cl. C09K 11/77

(52) U.S. Cl. CPC C09K 11/7787

(57) ABSTRACT

A stannate luminescent material, having the general molecular formula of Ln₂₋ₓEuₓSn₂O₇@SnO₂@M_{y}, wherein Ln is selected from one of Gd, Y and La; M is selected from at least one of Ag, Au, Pt, Pd and Cu metallic nanoparticles; 0<x<1.5; y is the ratio between the molar mass of M and the sum of the molar mass of Sn in Ln₂₋ₓEuₓSn₂O₇ and the molar mass of Sn in SnO₂@M_{y}, 0<y≦1×10⁻²; and @ represents coating; the stannate luminescent material uses M. as a core, SnO₂ as an inner shell, and Ln₂₋ₓEuₓSn₂O₇ as an outer shell. The stannate luminescent material is formed into a core-shell structure through the coating of at least one of Ag, Au, Pt, Pd and Cu metallic nanoparticles. The metallic nanoparticles improve the internal quantum efficiency of the luminescent material, thus enabling the stannate luminescent material to have a relatively high luminous intensity.

### FIELD OF THE INVENTION

The present disclosure relates to the field of luminescent materials, and more particularly relates to a stannate oxide luminescent material and preparation method thereof.

### BACKGROUND OF THE INVENTION

Field emission display (FED) is a newly developed flat panel display. The principle of FED is similar to that of conventional cathode ray tube (CRT), which generates images by using electron beam to bombard the luminescent material of the display. Compared with other flat panel displays (FPD), the FED has many potential advantages in brightness, viewing angle, response time, operating temperature range, power consumption, etc. One of the key factors in the preparation of FED with excellent performance is the preparation of luminescent materials.

However, the luminous intensity of the conventional luminescent materials is too low to obtain a FED with excellent luminescent properties.

### SUMMARY OF THE INVENTION

Accordingly, it is necessary to address the problem of low luminous intensity of the conventional luminescent materials and to provide a stannate luminescent material having a higher luminous intensity and preparation method thereof.

A stannate luminescent material has a general molecular formula of Ln₂₋ₓEuₓSn₂O₇@SnO₂@M_{y},

wherein Ln is selected from the group consisting of Gd, Y, and La;

M is at least one metal nanoparticles selected from the group consisting of Ag, Au, Pt, Pd, and Cu;

0<x≦1.5;

y is a molar ratio between M and the sum of Sn in Ln₂₋ₓEuₓSn₂O₇ and in SnO₂@M_{y}, 0<y≦1×10^{-2;}

@ represents coating; the stannate luminescent material uses M as a core, SnO₂ as an inner shell, and Ln₂₋ₓEuₓSn₂O₇ as an outer shell.

In one embodiment, 0.02≦x≦1.0.

In one embodiment, 1×10⁻⁵≦y≦5×10⁻³.

A method of preparing a stannate luminescent material includes the following steps:

preparing a sol containing M, wherein M is at least one metal nanoparticles selected from the group consisting of Ag, Au, Pt, Pd and Cu;

surface-treating the sol containing M, adjusting a pH value of the sol containing M to 10 to 12, heating the sol containing M at a temperature of 60° C. to 90° C. with stirring, adding sodium stannate, potassium stannate or tin tetrachloride, stirring to react, centrifuging and drying, calcining at a temperature of 300° C. to 500° C. for 1 to 6 hours to obtain SnO₂ powder coating M;

mixing compounds containing Ln and Eu, a fluxing agent, and the SnO₂ powder coating M according to a stoichiometry ratio in a molecular formula of Ln₂₋ₓEuₓSn₂O₇@SnO₂@M_{y} to obtain a mixture, grinding the mixture, wherein Ln is selected from the group consisting of Gd, Y, and La; 0<x≦1.5; y is a molar ratio between M and the sum of Sn in Ln₂₋ₓEuₓSn₂O₇ and in SnO₂@M_{y}, 0<y≦1×10⁻²; and

pre-heating the ground mixture at a temperature of 300° C. to 500° C. for 3 to 5 hours, cooling and grinding to obtain a pre-heated ground product, calcining the pre-heated ground product at a temperature of 1200° C. to 1400° C. for 1 to 24 hours, cooling and grinding to obtain the stannate luminescent material having the general molecular formula of Ln₂₋ₓEuₓSn₂O₇@SnO₂@M_{y}, wherein @ represents coating; the stannate luminescent material uses M as a core, SnO₂ as an inner shell, and Ln₂₋ₓEuₓSn₂O₇ as an outer shell.

In one embodiment, the preparing the sol containing M includes:

mixing and reacting a salt solution of at least one of Ag, Au, Pt, Pd, and Cu, an additive, and a reducing agent for 10 minutes to 5 minutes to obtain the sol containing M nanoparticles.

In one embodiment, a concentration of the salt solution of at least one of Ag, Au, Pt, Pd, and Cu ranges from 1×10⁻³ mol/L to 5×10⁻² mol/L.

In one embodiment, the additive is at least one selected from the group consisting of polyvinyl pyrrolidone, sodium citrate, cetyl trimethyl ammonium bromide, sodium lauryl sulfate, and sodium dodecyl sulfate; a concentration of additive in the sol containing M ranges from 1×10⁻⁴g/mL to 5×10⁻²g/mL.

In one embodiment, the reducing agent is at least one selected from the group consisting of hydrazine hydrate, ascorbic acid, sodium citrate, and sodium borohydride; a molar ratio of the reducing agent to a metal ion in the salt solution of at least one of Ag, Au, Pt, Pd, and Cu ranges from 3.6:1 to 18:1.

In one embodiment, the fluxing agent is boric acid or magnesium fluoride.

In one embodiment, a percentage of the molar amount of the fluxing agent to the molar amount of the stannate luminescent material is 0.1% to 5%.

The forgoing stannate luminescent material has a core-shell structure using at least one metal nanoparticles of Ag, Au, Pt, Pd, and Cu as the core, SnO₂ as an inner shell, and Ln₂₋ₓEuₓSn₂O₇ as an outer shell. The metal nanoparticles can improve the internal quantum efficiency of the luminescent material, so that the luminous intensity of the stannate luminescent material becomes higher.

### BRIEF DESCRIPTION OF THE DRAWINGS

FIG. 1 is a flow chart of a method of preparing a stannate oxide luminescent material in accordance with one embodiment;

FIG. 2 is a graphical representation of cathodoluminescence spectrum under a voltage of 1.5 kV of the stannate luminescent material of Y_{1.9}Eu_{0.1}Sn₂O₇@SnO₂@Au_{1.5×10}_{^{−}}₄ prepared in accordance with Example 2 and the luminescent material of Y_{1.9}Eu_{0.1}Sn₂O₇@SnO₂ without coating metal nanoparticles.

### DETAILED DESCRIPTION OF THE EMBODIMENTS

Reference will now be made to the drawings to describe, in detail, embodiments of the present stannate luminescent material and preparation method thereof

An embodiment of a stannate luminescent material is provided having the general molecular formula of Ln₂₋ₓEuₓSn₂O₇@SnO₂@M_{y};

wherein Ln is selected from the group consisting of gadolinium (Gd), yttrium (Y), and lanthanum (La);

M is at least one metal nanoparticles selected from the group consisting of silver (Ag), gold (Au), platinum (Pt), palladium (Pd), and copper (Cu).

0<x≦1.5, preferably 0.02≦x≦1.0;

y is a molar ratio between M and the sum of Sn in Ln₂₋ₓEuₓSn₂O₇ and in SnO₂@M_{y}, 0<y≦1×10⁻², preferably 1×10⁻⁵≦y≦5×10⁻³; 100341 @ represents coating; the stannate luminescent material uses M as a core, SnO₂ as an inner shell, and Ln₂₋ₓEuₓSn₂O₇ as an outer shell.

As the core of the stannate luminescent material, metal nanoparticles M can cause a surface plasmon resonance effect, so as to improve the internal quantum efficiency of the stannate luminescent material.

The stannate Ln₂Sn₂O₇ exhibits a relative high chemical stability and high temperature stability. In the Ln₂₋ₓEuₓSn₂O₇ outer shell, Eu is doped in the stannate Ln₂Sn₂O₇ to replace partial Ln, such that the obtained stannate composition has an excellent stability.

The divalent Eu ion is an activating ion in the stannate luminescent material, which drives the stannate luminescent material to emit red light.

A molar ratio between the Ln and the Eu is 2−x:x, 0<x≦1.5, preferably 0.02≦x≦1.0, so as to form an emitting center, thus increasing the luminous intensity, while avoiding luminescence quenching caused by excessive concentration of Eu²⁺.

y is the molar ratio between M and the sum of Sn in Ln₂₋ₓEuₓSn₂O₇ and in SnO₂@M_{y}, 0<y≦1×10⁻², preferably 1×10⁻⁵≦y≦5×10⁻³, such that the surface plasmon resonance effect can be produced to improve the internal quantum efficiency of the stannate luminescent material, while avoiding luminescence quenching caused by excessive content of M.

The forgoing stannate luminescent material has a core-shell structure using at least one metal nanoparticles of Ag, Au, Pt, Pd, and Cu as the core, SnO₂ as an inner shell, and Ln₂₋ₓEuₓSn₂O₇ as an outer shell. The metal nanoparticles can improve the internal quantum efficiency of the luminescent material, so that the luminous intensity of the stannate luminescent material becomes higher.

Since M, SnO₂, and Ln₂₋ₓEuₓSn₂O₇ are all chemical stable substance, the stannate luminescent material with the core-shell structure exhibits a better stability, as well as the higher luminous intensity.

Accordingly, the stannate luminescent material can be widely applied in the field of display and lighting applications due to its high stability and good luminescent properties. When the stannate luminescent material is applied to the field emission display (FED), the luminescence properties the field emission display (FED) can be improved,

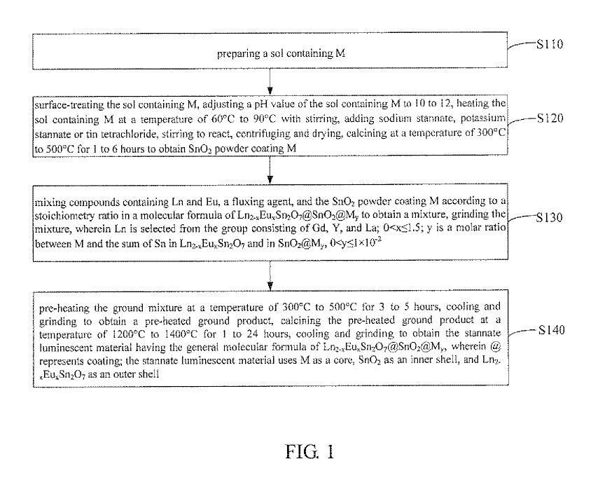

Referring to FIG. 1, an embodiment of a method of preparing a stannate luminescent material includes the following steps:

In step S110, a sol containing M is prepared.

M is at least one metal nanoparticles selected from the group consisting of Ag, Au, Pt, Pd and Cu.

The step of preparing the sol containing M includes: mixing and reacting a salt solution of at least one of Ag, Au, Pt, Pd, and Cu, an additive, and a reducing agent to obtain the sol containing M nanoparticles. In order to guarantee that the sol containing M is obtained, the reaction time is preferably ranged from 10 to 45 minutes to save energy.

The salt solution of Ag, Au, Pt, Pd, and Cu can be a chloride solution, a nitrate solution or the like of the Ag, Au, Pt, Pd, and Cu, The concentration of the salt solution of Ag, Au, Pt, Pd, and Cu can be determined according to the actual needs, preferably ranges from 1×10⁻³ mol/L to 5×10⁻² mol/L.

The additive is at least one selected from the group consisting of polyvinyl pyrrolidone, sodium citrate, cetyl trimethyl ammonium bromide, sodium lauryl sulfate, and sodium dodecyl sulfate. The concentration of additive in the sol containing M ranges from 1×10⁻⁴g/mL to 5×10⁻²g/mL.

The reducing agent is at least one selected from the group consisting of hydrazine hydrate, ascorbic acid, sodium citrate, and sodium borohydride. The reducing agent is firstly formulated into an aqueous solution with a concentration of 1×10⁻⁴mol/L to 1 mol/L, then is mixed and reacted with the salt solution of at least one of Ag, Au, Pt, Pd, and Cu, and the additive.

A molar ratio of the reducing agent to a metal ion in the salt solution of at least one of Ag, Au, Pt, Pd, and Cu ranges from 3.6:1 to 18:1.

Under the effect of the reducing agent and additives, Ag, Au, Pt, Pd or Cu ions are reduced to Ag, Au, Pt, Pd or Cu metal nanoparticles and dispersed in a solvent, such that the sol containing M is obtained.

In step S120, the sol containing M is surface-treated, a pH value of the sol containing M is adjusted to 10 to 12, the sol containing M is then heated at a temperature of 60° C. to 90° C. with stirring, sodium stannate, potassium stannate or tin tetrachloride is added, stirring to react, centrifuging and drying, calcining at a temperature of 300° C. to 500° C. for 1 to 6 hours to obtain SnO₂ powder coating M.

For ease of coating, the sol containing M obtained from the step S110 is firstly surface-treated to form a stable SiO₂ powder coating M, referred hereafter as SiO₂@M.

Specifically, the step of surface-treating the sol containing M includes: adding the sol containing M to a polyvinyl pyrrolidone (PVP) aqueous solution having a concentration of 0.05 g/ml to 0.1 g/ml and stirring for 8 to 18 hours.

The pH value of the surface-treated sol containing M is adjusted to 10 to 12 using sodium hydroxide (NaOH) or ammonia (NH₃.H₂O), the sol containing M is then heated in a water bath at a constant temperature of 60° C. to 90° C. with stirring. After adding sodium stannate (Na₂SnO₃), potassium stannate (K₂SnO₃) or tin tetrachloride (SnCl₄) rapidly with stirring, the system is reacted, centrifuged and dried to remove water and solvent, calcined to obtain the SnO₂ powder coating M.

The reaction and stirring time is preferably 1 to 5 hours. During the reaction, sodium stannate (Na₂SnO₃), potassium stannate (K₂SnO₃) or tin tetrachloride (SnCl₄) hydrolyzes to form tin hydroxide Sn(OH)₄, which is calcined to obtain SnO₂. The SnO₂ coats on the surface of M to form the SnO₂ powder coating M. For example, the reaction equation using sodium stannate (Na₂SnO₃) is as shown as follows:

NaSnO₃+H₂O+CO₂→Sn(OH)₄+Na₂CO₃;

Sn(OH)₄→SnO₂→2H₂O.

The reaction mechanism using potassium tin (K₂SnO₃) is the same as that of sodium stannate (Na₂SnO₃).

The reaction equation using tin tetrachloride (SnCl₄) is as shown as follows:

SnCl₄+4OH⁻→Sn(OH)₄+4Cl⁻;

Sn(OH)₄→SnO₂+2H₂O.

In the step of calcining the tin hydroxide Sn(OH)₄ to obtain tin oxide (SnO₂), the calcining temperature ranges from 300° C. to 500° C., the calcining time is 1 to 6 hours.

In step S130, compounds containing Ln and Eu, a fluxing agent, and the SnO₂ powder coating M are mixed according to a stoichiometry ratio in a molecular formula of Ln₂₋ₓEuₓSn₂O₇@SnO₂@M_{y} to obtain a mixture, the mixture is ground, wherein Ln is selected from the group consisting of Gd, Y, and La; 0<x≦1.5; y is a molar ratio between M and the sum of Sn in Ln₂₋ₓEuₓSn₂O₇ and in SnO₂@M_{y}, 0<y≦1×10⁻².

The compounds containing Ln can be oxides, carbonates, nitrates, oxalates and chlorides of Ln. For example, the compounds containing Ln can be yttrium carbonate (Y₂(CO₃)₃), yttrium oxide (Y₂O₃), or the like.

The compounds containing Eu can be oxides, carbonates, nitrates, oxalates and chlorides of Eu. For example, the compounds containing Eu can be europium carbonate (Eu₂(CO₃)₃), europium oxide (Eu₂O₃), or the like.

The mixture of compounds containing Ln and Eu, and the SnO₂ powder coating M are used as raw materials to generate stannate luminescent material. The fluxing agent can cause a more sufficient reaction, and the reaction temperature can be reduced, thereby reducing energy consumption.

The grinding of the compounds containing Ln and Eu, the fluxing agent, and the SnO₂ powder coating M can promote the chemical reaction of the raw materials, and is in favor of obtaining the product in a smaller particle size.

Preferably, the fluxing agent is boric acid (H₃BO₃) or magnesium fluoride (MgF₂). A percentage of the molar amount of the fluxing agent to the molar amount of the stannate luminescent material is 0.1% to 5%.

In step S140, the ground mixture is pre-heated at a temperature of 300° C. to 500° C. for 3 to 5 hours, cooling and grinding to obtain a pre-heated ground product, calcining the pre-heated ground product at a temperature of 1200° C. to 1400° C. for 1 to 24 hours, cooling and grinding to obtain the stannate luminescent material having the general molecular formula of Ln₂₋ₓEuₓSn₂O₇@SnO₂@M_{y}, wherein @ represents coating; the stannate luminescent material uses M as a core, SnO₂ as an inner shell, and Ln₂₋ₓEuₓSn₂O₇ as an outer shell.

The main effect of calcination is to trigger the chemical reaction between the components of the raw materials, thus forming a matrix with a lattice structure. Therefore, the activator can enter the matrix and be positioned at the gap in the matrix lattice or replace the lattice atom. The preheating can facilitate the formation of crystal lattice during calcinations.

After calcining, cooling, and grinding, the stannate luminescent material with a smaller particle size and more uniform particle size distribution is obtained.

The preparation method of the stannate luminescent material uses metal nanoparticles M as the core, and coats the surface of M with SnO₂ to form the inner shell using a sol method, and then coats the surface of SnO₂ with stannate composition Ln₂₋ₓEuₓSn₂O₇ to form the outer shell using high-temperature solid-phase method, such that the stannate luminescent material with a core-shell structure is obtained. The prepared stannate luminescent materials have many advantages such as high luminous intensity, good stability and excellent luminescence performance.

The preparation method of the stannate luminescent material has a simple process, low equipment requirements, no pollution, and is easy to control, which is suitable for industrial production with a broad application prospects.

The specific examples are described below.

### EXAMPLE 1

This example describes a process of preparation of Y_{1.98}Eu_{0.02}Sn₂O₇@SnO₂@Pd_{1×10}_{^{−}}₅ by using high-temperature solid-phase method.

Preparation of sol containing Pd nanoparticles was described below.

0.22 mg of palladium chloride (PdCl₂.2H₂O) was dissolved in 19 mL of deionized water. After the palladium chloride was fully dissolved, 11.0 mg of sodium citrate and 4.0 mg of sodium lauryl sulfate were weighed and dissolved into the palladium chloride aqueous solution under magnetic stirring. 3.8 mg of sodium borohydride was weighed and dissolved into 10 mL of deionized water to obtain a sodium borohydride reducing solution with a concentration of 1× ⁻² mol/L. Under magnetic stirring, 1 mL of sodium borohydride solution with a concentration of 1× ⁻² mol/L was fast added to the palladium chloride aqueous solution. After reaction for 20 minutes, 20 mL of sol containing Pd nanoparticles was obtained with a Pd content of 5×10⁻⁵mol/L.

Preparation of SiO₂@Pd was described below.

1.5 mL of sol containing Pd nanoparticles (5×10⁻⁵mol/L) was pipetted and placed in a beaker, 8 mL of PVP solution (0.005 g/mL) was added, magnetically stirred for 16 hours to obtain a surface treated sol containing Pd nanoparticles. The pH value of the surface treated sol containing Pd nanoparticles was adjusted to 10.5 using NaOH. After stirring for 10 minutes, the sol was transferred to a 60° C. water bath with constant temperature heating and stirring, 25 mL of Na₂SnO₃ solution (0.3 mol/L) was rapidly added with stirring. After stirring for 2 hours, the sol was centrifuged and dried, calcined at 500° C. for 1 hour to obtain SnO₂ powder coating Pd, i.e. SiO₂@Pd.

Preparation of Y_{1.98}Eu_{0.02}Sn₂O₇@SnO₂@Pd_{1×10}_{^{−}}₅ was described below.

0.8856 g of yttrium carbonate (Y₂(CO₃)₃), 0.0242 g of europium carbonate (Eu₂(CO₃)₃), 0.9042 g of SnO₂ powder coating Pd, and 0.0077 g of boric acid (H₃BO₃) were weighed according to the stoichiometry ratio, After all the raw materials were placed in an agate mortar and thoroughly ground, they were placed into a corundum crucible and pre-sintered at 400° C. for 4 hours, then cooled to room temperature, thoroughly ground again. The ground product was finally calcined at 1200° C. for 10 hours, cooled to room temperature, ground to obtain the stannate luminescent material Y_{1.98}Eu_{0.02}Sn₂O₇@SnO₂@Pd_{1×10}_{^{−}}₅.

### EXAMPLE 2

This example describes a process of preparation of Y_{1.9}Eu_{0.1}Sn₂O₇@SnO₂@Au_{1.5×10}_{^{−}}₄ by using high-temperature solid-phase method.

0.21 mg of chloroauric acid (AuCl₃HCl.4H₂O) was dissolved in 16.8 mL of deionized water. After the chloroauric acid was fully dissolved, 14 mg of sodium citrate and 6 mg of cetyl trimethyl ammonium bromide were weighed and dissolved into the chloroauric acid aqueous solution under magnetic stirring. 1.9 mg of sodium borohydride and 17.6 mg of ascorbic acid were weighed and dissolved into 10 mL of deionized water, respectively, to obtain a 10 mL of sodium borohydride solution with a concentration of 5×10⁻³ mol/L and a 10 mL of ascorbic acid solution with a concentration of 1× ⁻² mol/L. Under magnetic stirring, 0.08 mL of sodium borohydride solution was firstly added to the chloroauric acid aqueous solution, after stirring for 5 minutes, 3.12 mL of ascorbic acid solution with a concentration of 1× ⁻² mol/L was then added to the chloroauric acid aqueous solution. After reaction for 30 minutes, 20 mL of sol containing Au nanoparticles was obtained with an Au content of 5×10⁻⁵ mol/L.

Preparation of SiO₂@Au was described below.

15 mL of sol containing Au nanoparticles (5×10⁻⁵ mol/L) was pipetted and placed in a beaker, of PVP solution (0.1 g/mL) was added, magnetically stirred for 8 hours to obtain a surface treated sol containing Au nanoparticles. The pH value of the surface treated sol containing Au nanoparticles was adjusted to 12 using NaOH. After stirring for 5 minutes, the sol was transferred to a 90° C. water bath with constant temperature heating and stirring, 20 mL, of K₂SnO₃ solution (0.25 mol/L) was rapidly added with stirring. After stirring for 3 hours, the sol was centrifuged and dried, calcined at 300° C. for 6 hours to obtain SnO₂ powder coating Au, i.e. SiO₂@Au.

Preparation of Y_{1.9}Eu_{0.1}Sn₂O₇@SnO₂@Au_{1.5×10}_{^{−}}₄ was described below.

0.5363 g of yttrium oxide (Y₂O₃), 0.0440 g of europium oxide (Eu₂O₃), SnO₂ powder coating Au, and 0.0077 g of boric acid (H₃BO₃) were weighed according to the stoichiometry ratio. After all the raw materials were placed in an agate mortar and thoroughly ground, they were placed into a corundum crucible and pre-sintered at 500° C. for 3 hours, then cooled to room temperature, thoroughly ground again. The ground product was finally calcined at 1400° C. for 5 hours, cooled to room temperature, ground to obtain the stannate luminescent material Y_{1.9}Eu_{0.1}Sn₂O₇@SnO₂@Au_{1.5×10}_{^{−}}₄ .

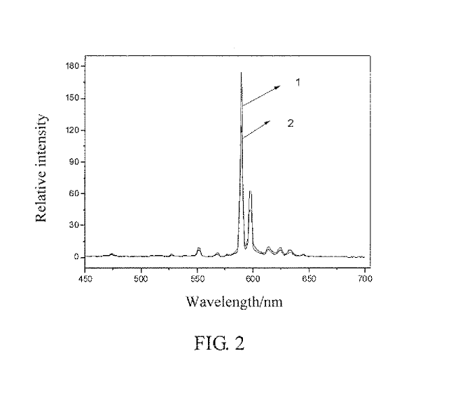

FIG. 2 is a graphical representation of cathodoluminescence spectrum under a voltage of 1.5 kV of the luminescent material of Y_{1.9}Eu_{0.1}Sn₂O₇@SnO₂@Au_{1.5×10}_{^{−}}₄ coating Au nanoparticles prepared in accordance with Example 2, and the luminescent material of Y_{1.9}Eu_{0.1}Sn₂O₇@SnO₂ without coating metal nanoparticles. It can be seen from FIG. 2 that, at an emission peak of 590 nm, the emission intensity of luminescent material of Y_{1.9}Eu_{0.1}Sn₂O₇@SnO₂@Au_{1.5×10}_{^{−}}₄ coating Au nanoparticles is enhanced by 40% comparing to luminescent material of Y_{1.9}Eu_{0.1}Sn₂O₇@SnO₂ without coating metal nanoparticles.

### EXAMPLE 3

This example describes a process of preparation of Y_{1.5}Eu_{0.5}Sn₂O₇@SnO₂@Ag_{2.5×10}_{^{−}}₄ by using high-temperature solid-phase method.

Preparation of sol containing Ag nanoparticles was described below.

3.4 mg of silver nitrate (AgNO₃) was dissolved in 18.4 mL of deionized water. After the silver nitrate was fully dissolved, 42 mg of sodium citrate was weighed and dissolved into the silver nitrate aqueous solution under magnetic stirring. 5.7 mg of sodium borohydride was weighed and dissolved into 10 mL of deionized water to obtain a 10 mL of sodium borohydride solution with a concentration of 1.5×10⁻²mol/L. Under magnetic stirring, 1.6 mL of sodium borohydride solution (1.5×10⁻²mol/L) was added to the silver nitrate aqueous solution. After reaction for 10 minutes, 20 mL of sol containing Ag nanoparticles was obtained with an Ag content of 1× ⁻³ mol/L.

Preparation of SiO₂@Ag was described below.

1.2 mL of sol containing Ag nanoparticles (1× ⁻³ mol/L) was pipetted and placed in a beaker, 10 mL of PVP solution (0.01 g/mL) was added, magnetically stirred for 12 hours to obtain a surface treated sol containing Ag nanoparticles, The pH value of the surface treated sol containing Ag nanoparticles was adjusted to 11 using ammonia, After stirring for 5 minutes, the sol was transferred to an 80° C. water bath with constant temperature heating and stirring, 15 mL of SnCl₄ solution (0.32 mol/L) was rapidly added with stirring. After stirring for 3 hours, the sol was centrifuged and dried, calcined at 400° C. for 4 hours to obtain SnO₂ powder coating Ag, i.e. SiO₂@Ag.

Preparation of Y_{1.5}Eu_{0.5}Sn₂O₇@SnO₂@Ag_{2.5×10}_{^{−}}₄ was described below.

0.8284 g of yttrium oxalate Y₂(C₂O₄)₃, 0.2129 g of europium oxalate Eu₂(C₂O₄)₃, 0.8288 g of SnO₂ powder coating Ag, and 0.0015 g of boric acid (H₃BO₃) were weighed according to the stoichiometry ratio. After all the raw materials were placed in an agate mortar and thoroughly ground, they were placed into a corundum crucible and pre-sintered at 500° C. for 2 hours, then cooled to room temperature, thoroughly ground again. The ground product was finally calcined at 1300° C. for 5 hours, cooled to room temperature, ground to obtain the stannate luminescent material Y_{1.5}Eu_{0.5}Sn₂O₇@SnO₂@Ag_{2.5×10}_{^{−}}₄.

### EXAMPLE 4

This example describes a process of preparation of Gd_{1.0}Eu_{1.0}Sn₂O₇@SnO₂@Pt_{5×10}_{^{−}}₃ by using high-temperature solid-phase method.

Preparation of sol containing Pt nanoparticles was described below.

25.9 mg of chloroplatinic acid (H₂PtCl₆.6H₂O) was dissolved in 17 mL of deionized water. After the chloroplatinic acid was fully dissolved, 40.0 mg of sodium citrate and 60.0 mg of sodium lauryl sulfate were weighed and dissolved into the chloroplatinic acid aqueous solution under magnetic stirring. 1.9 mg of sodium borohydride was weighed and dissolved into 10 mL of deionized water to obtain 10 mL of sodium borohydride aqueous solution with a concentration of 5×10⁻³ mol/L. 10 mL of hydrazine hydrate solution (5×10⁻² mol/L) was prepared at the same time. Under magnetic stirring, 0.4 mL of sodium borohydride solution was added dropwise to the chloroplatinic acid aqueous solution and stirred for 5 minutes, then 2.6 mL of hydrazine hydrate (5×10⁻² mol/L) was added dropwise to the chloroplatinic acid aqueous solution. After reaction for 40 minutes, 10 mL of sol containing Pt nanoparticles was obtained with a Pt content of 2.5×10⁻³mol/L.

Preparation of SiO₂@Pt was described below.

8 mL of sol containing Pt nanoparticles (2.5×10⁻³mol/L) was pipetted and placed in a beaker, 4 mL of PVP solution (0.02 g/mL) was added, magnetically stirred for 18 hours to obtain a surface treated sol containing Pt nanoparticles. The pH value of the surface treated sol containing Pt nanoparticles was adjusted to 10.5 using ammonia. After stirring for 5 minutes, the sol was transferred to a 70° C. water bath with constant temperature heating and stirring, 10 mL of Na₂SnO₃ solution (0.4 mol/L) was rapidly added with stirring. After stirring for 5 hours, the sol was centrifuged and dried, calcined at 300° C. for 4 hours to obtain SnO₂ powder coating Pt, i.e. SiO₂@Pt.

Preparation of Gd_{1.0}Eu_{1.0}Sn₂O₇@SnO₂@Pt_{5×10}_{^{−}}₃ was described below,

1.1284 g of gadolinium nitrate (Gd(NO₃)₃.6H₂O), 1.1152 g of europium nitrate (Eu(NO₃)₃.6H₂O), 0.7535 g of SnO₂ powder coating Pt, and 0.0031 g of magnesium fluoride (MgF₂) were weighed according to the stoichiometry ratio. After all the raw materials were placed in an agate mortar and thoroughly ground, they were placed into a corundum crucible and pre-sintered at 300° C. for 5 hours, then cooled to room temperature, thoroughly ground again. The ground product was finally calcined at 1300° C. for 24 hours, cooled to room temperature, ground to obtain the stannate luminescent material Gd_{1.0}Eu_{1.0}Sn₂O₇@SnO₂@Pt_{5×10}_{^{−}}₃.

### EXAMPLE 5

This example describes a process of preparation of La_{0.5}Eu_{1.5}Sn₂O₇@SnO₂@Cu_{1×10}_{^{−}}₄ by using high-temperature solid-phase method.

Preparation of sol containing Cu nanoparticles was described below.

1.6 mg of copper nitrate was dissolved in 16 mL of ethanol. After the copper nitrate was fully dissolved, 12 mg of PVP was added with stirring. 0.4 mg of sodium borohydride was dissolved into 10 mL of ethanol to obtain a sodium borohydride alcoholic solution with a concentration of 1× ⁻³ mol/L. 4 mL of sodium borohydride alcoholic solution was added dropwise to the copper nitrate solution. After stirring and reacting for 10 minutes, 20 mL of sol containing Cu nanoparticles was obtained with a Cu content of 4× ⁻⁴ mol/L.

Preparation of SiO₂@Cu was described below.

1.5 mL of sol containing Cu nanoparticles (4× ⁻⁴ mol/L) was pipetted and placed in a beaker, 5 mL of PVP solution (0.03 g/mL) was added, magnetically stirred for 10 hours to obtain a surface treated sol containing Cu nanoparticles. The pH value of the surface treated sol containing Cu nanoparticles was adjusted to 10.5 using NaOH. After stirring for 15 minutes, the sol was transferred to a 60° C. water bath with constant temperature heating and stirring, 30 mL of Na₂SnO₃ solution (0.2 mol/L) was rapidly added with stirring. After stirring for 1 hour, the sol was centrifuged and dried, calcined at 300° C. for 5 hours to obtain SnO₂ powder coating Cu, i.e. SiO₂@Cu.

Preparation of La_{0.5}Eu_{1.5}Sn₂O₇@SnO₂@Cu_{1×10}_{^{−}}₄ was described below.

0.3066 g of lanthanum chloride (LaCl₃), 0.9686 g of europium chloride (EuCl₃), 0.7535 g of SnO₂ powder coating Cu, and 0.0046 g of boric acid (H₃BO₃) were weighed according to the stoichiometry ratio. After all the raw materials were placed in an agate mortar and thoroughly ground, they were placed into a corundum crucible and pre-sintered at 500° C. for 5 hours, then cooled to room temperature, thoroughly ground again. The ground product was finally calcined at 1200° C. for 12 hours, cooled to room temperature, ground to obtain the stannate luminescent material La_{0.5}Eu_{1.5}Sn₂O₇@SnO₂@Cu_{1×10}_{^{−}}₄.

### EXAMPLE 6

This example describes a process of preparation of La_{1.5}Eu_{0.5}Sn₂O₇@SnO₂@(Ag_{0.5}/Au_{0.5})_{1.25×10}_{^{−}}₃ by using high-temperature solid-phase method.

Preparation of sol containing Ag_{0.5}/Au_{0.5} nanoparticles was described below.

6.2 mg of chloroauric acid (AuCl₃.HCl.4H₂O) and 2.5 mg of AgNO₃ were dissolved in 28 mL of deionized water. After they were fully dissolved, 22 mg of sodium citrate and 20 mg of PVP were weighed and added to the mixture solution under magnetic stirring. 5.7 mg of sodium borohydride was dissolved into 10 mL of deionized water to obtain a sodium borohydride aqueous solution with a concentration of 1.5×10⁻²mol/L. 2 mL of sodium borohydride aqueous solution (1.5×10⁻²mol/L) was added to the mixture solution under a magnetic stirring environment. After reacting for 20 minutes, 30 mL of sol containing Ag_{0.5}/Au_{0.5} nanoparticles was obtained with a sum metal (Ag+Au) concentration of 1× ⁻³ mol/L.

Preparation of SiO₂@(Ag_{0.5}/Au_{0.5}) was described below.

5 mL of sol containing Ag_{0.5}/Au_{0.5} nanoparticles (sum metal (Ag+Au) concentration of 1× ⁻³ mol/L) was pipetted and placed in a beaker, 10 mL of PVP solution (0.1 g/mL) was added, magnetically stirred for 12 hours to obtain a surface treated sol containing Ag_{0.5}/Au_{0.5} nanoparticles. The pH value of the surface treated sol containing Ag_{0.5}/Au_{0.5} nanoparticles was adjusted to 10.5 using NaOH. After stirring for 15 minutes, the sol was transferred to a 60° C. water bath with constant temperature heating and stirring, 30 mL of Na₂SnO₃ solution (0.2 mol/L) was rapidly added with stirring. After stirring for 1 hour, the sol was centrifuged and dried, calcined at 500° C. for 1 hour to obtain SnO₂ powder coating Ag and Au, i.e. SiO₂@(Ag_{0.5}/Au_{0.5}).

Preparation of La_{1.5}Eu_{0.5}Sn₂O₇@SnO₂@(Ag_{0.5}/Au_{0.5})_{1.25×10}_{^{−}}₃ was described below.

0.6109 g of lanthanum oxide (La₂O₃), 0.2200 g of europium oxide (Eu₂O₃), 0.7636 g of SnO₂ powder coating Ag and Au, and 0.0046 g of boric acid (H₃BO₃) were weighed according to the stoichiometry ratio. After all the raw materials were placed in an agate mortar and thoroughly ground, they were placed into a corundum crucible and pre-sintered at 400° C. for 5 hours, then cooled to room temperature, thoroughly ground again. The ground product was finally calcined at 1400° C. for 12 hours, cooled to room temperature, ground to obtain the stannate luminescent material La_{1.5}Eu_{0.5}Sn₂O₇@SnO₂@(Ag_{0.5}/Au_{0.5})_{1.25×10}_{^{−}}₃.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

1. A stannate luminescent material, having a general molecular formula of Ln₂₋ₓEuₓSn₂O₇@SnO₂@M_{y},
wherein Ln is selected from the group consisting of Gd, Y, and La;
M is at least one metal nanoparticles selected from the group consisting of Ag, Au, Pt, Pd, and Cu;
0<x≦1.5;
y is a molar ratio between M and the sum of Sn in Ln₂₋ₓEuₓSn₂O₇ and in SnO₂@M_{y}, 0<y≦1×10⁻²;
@ represents coating; the stannate luminescent material uses M as a core, SnO₂ as an inner shell, and Ln₂₋ₓEuₓSn₂O₇ as an outer shell.

2. The stannate luminescent material according to claim I, wherein 0.02≦x≦1.0.

3. The stannate luminescent material according to c aim 1, wherein 1×10⁻⁵≦y≦5×10⁻³.

4. A method of preparing a stannate luminescent material, comprising the following steps:
preparing a sot containing M, wherein M is at least one metal nanoparticles selected from the group consisting of Ag, Au, Pd and Cu;
surface-treating the sol containing M, adjusting a pH value of the sol containing M to 10 to 12, heating the sol containing M at a temperature of 60° C. to 90° C. with stirring, adding sodium stannate, potassium stannate or tin tetrachloride, stirring to react, centrifuging and drying, calcining at a temperature of 300° C. to 500° C. for 1 to 6 hours to obtain SnO₂ powder coating M;
mixing compounds containing Ln and Eu, a fluxing agent, and the SnO₂ powder coating M according to a stoichiometry ratio in a molecular formula of Ln₂₋ₓEuₓSn₂O₇@SnO₂@M_{y} to obtain a mixture, grinding the mixture, wherein Ln is selected from the group consisting of Gd, Y, and La; 0<x≦1.5; y is a molar ratio between Ni and the sum of Sn in Ln₂₋ₓEuₓSn₂O₇ and in SnO₂@M_{y}, 0<y≦1×10⁻²; and
pre-heating the ground mixture at a temperature of 300° C. to 500° C. for 3 to 5 hours, cooling and grinding to obtain a pre-heated ground product, calcining the pre-heated ground product at a temperature of 1200° C. to 1400° C. for 1 to 24 hours, cooling and grinding to obtain the stannate luminescent material having the general molecular formula of Ln₂₋ₓEuₓSn₂O₇@SnO₂@M_{y}, wherein @ represents coating; the stannate luminescent material uses M as a core, SnO₂ as an inner shell, and Ln₂₋ₓEuₓSn₂O₇ as an outer shell.

5. The method of preparing the stannate luminescent material according to claim 5, wherein the preparing the sot containing NI comprises:
mixing and reacting a salt solution of at least one of Ag, Au, Pt, Pd, and Cu, an additive, and a reducing agent for 10 minutes to 45 minutes to obtain the sol containing M nanoparticles.

6. The method of preparing the stannate luminescent material according to claim 5, wherein a concentration of the salt solution of at least one of Ag, Au, Pt, Pd, and Cu ranges from 1×10⁻³ mol/L to 5×10⁻² mol/L.

7. The method of preparing the stannate luminescent material according to claim 5, wherein the additive is at least one selected from the group consisting of polyvinyl pyrrolidone, sodium citrate, cetyl trimethyl ammonium bromide, sodium lauryl sulfate, and sodium dodecyl sulfate; a concentration of additive in the sol containing M ranges from 1×10⁻⁴g/mL to 5×10⁻²g/mL.

8. The method of preparing the stannate luminescent material according to claim 5, wherein the reducing agent is at least one selected from the group consisting of hydrazine hydrate, ascorbic acid, sodium citrate, and sodium borohydride; a molar ratio of the reducing agent to a metal ion in the salt solution of at least one of Ag, Au, Pt, Pd, and Cu ranges from 3.6:1 to 18:1.

9. The method of preparing the stannate luminescent material according to claim 4, wherein the fluxing agent is boric acid or magnesium fluoride.

10. The method of preparing the stannate luminescent material according to claim 4, wherein a percentage of the molar amount of the fluxing agent to the molar amount of the stannate luminescent material is 0.1% to 5%.

11. The method of preparing the stannate luminescent material according to claim 9, wherein a percentage of the molar amount of the fluxing agent to the molar amount of the stannate luminescent material is 0.1% to 5%.
